(19) United States
(12) Patent Application Publication
(10) Pub. No.: US 2020/0269982 A1
(43) Pub. Date: Aug. 27, 2020

(54) AIRCRAFT COMPRISING A STAGGERED BOARDING GATE

(71) Applicant: DASSAULT AVIATION, 75008 (FR)

(72) Inventors: Christophe HARROIS, SAINT CLOUD (FR); Jean-Rémi BILLON, SAINT CLOUD (FR); Séverine ASFAUX, SAINT CLOUD (FR)

(21) Appl. No.: 16/792,488

(22) Filed: Feb. 17, 2020

(30) Foreign Application Priority Data
Feb. 22, 2019 (FR) FR 19 01806

(51) Int. Cl. B64D 11/00; B64D 11/04; B64C 1/14

(52) U.S. Cl. CPC B64D 11/00; B64C 1/1461; B64C 1/1423; B64D 11/04

(57) ABSTRACT

An aircraft (10) includes a fuselage (12) delimiting a cockpit (14), a passenger entry area (18) and a passenger cabin (16) configured to accommodate passengers during a flight phase. The entry area (18) is interposed longitudinally between the cockpit (14) and the cabin. The cockpit and the entry area are delimited by a front separating element (24) and the entry area and the cabin are delimited by a rear separating element (26). The fuselage delimits a side boarding door (20). A transverse median plane (66) of the boarding door is placed at a distance from the front separating element, considered along the longitudinal axis, greater than 39% of the length between the front separating element and the rear separating element, considered along the longitudinal axis.

The present disclosure relates to an aircraft comprising a fuselage, the fuselage extending along a longitudinal axis and delimiting a cockpit, a passenger entry area, and a passenger cabin, the cabin being configured to accommodate passengers of the aircraft during a flight phase of the aircraft, the entry area being interposed longitudinally between the cockpit and the cabin; the cockpit and the entry area being delimited by a front separating element and the entry area and the cabin being delimited by a rear separating element; the fuselage delimiting a side passenger boarding door opening in the entry area.

The present disclosure applies to aircraft in civil aviation, in particular in business aviation.

### BACKGROUND

In this type of aircraft, the entry area commonly comprises toilets and a galley for in-flight passenger catering services. By regulation, it comprises a rest area for the crew.

The entry area of these aircraft is arranged such that a passenger boarding through the boarding door first sees a door corresponding to the toilets and must pass through an aisle by passing in front of the galley, before reaching his seat in the cabin.

Furthermore, when the flight attendants greet passengers, they necessarily place themselves in the circulation path of the passengers moving toward the cabin.

This arrangement therefore does not provide fully satisfactory comfort for passengers boarding the aircraft.

### SUMMARY

One aim of the present disclosure is to provide a high level of comfort for passengers boarding the aircraft, while improving traffic in the aircraft for navigating personnel and passengers.

To that end, the present disclosure relates to an aircraft of the aforementioned type, wherein a transverse median plane of the passenger boarding door is placed at a distance from the front separating element, considered along the longitudinal axis, greater than 39% of the length between the front separating element and the rear separating element, considered along the longitudinal axis.

According to other advantageous aspects of the invention, the aircraft includes one or more of the following features, considered alone or according to all technically possible combinations:
the entry area comprises at least one crew rest area, the crew rest area comprising a rest surface on which a resting crew member can sit and/or lie down, the crew rest area being arranged on the side of the fuselage opposite the boarding door and facing the boarding door;
the entry area comprises at least one crew rest area, the crew rest area comprising a rest surface on which a resting crew member can sit and/or lie down, the crew rest area being arranged on the same side of the fuselage as the boarding door and being arranged longitudinally between the cockpit and the boarding door;
said median plane is positioned longitudinally at a distance from the front separating element greater than 70% of the length between the front separating element and the rear separating element;
said median plane is positioned longitudinally at a distance from the front separating element less than 50% of the length between the front separating element and the rear separating element;
the minimum distance, considered along the longitudinal axis, separating the front separating element and a first free side edge of the boarding door is greater than 0.9 m;
the front separating element and the rear separating element each comprise a frame delimited by the fuselage and a concealing element received in the frame, the concealing element for example being a door or a curtain;
the passenger boarding door is adjoined to the rear separating element;
the entry area comprises a storage space inserted between the boarding door and the rear separating element;
at least one porthole is arranged laterally in the fuselage across from the passenger boarding door;
the entry area comprises at least one galley intended for in-flight passenger services, the galley being arranged at least partially across from the passenger boarding door;
the entry area comprises a central circulation passage connecting the front separating element to the rear separating element, the crew rest area and the galley being arranged on either side of the central circulation passage;
the entry area is devoid of another separating element, comprising a frame delimited by the fuselage and a concealing element received in the frame, distinct from the front and rear separating elements;
the fuselage is devoid of door placed longitudinally across from the boarding door;
the aircraft has a maximum takeoff weight of less than 55,000 kg and/or is configured for a maximum permissible number of passengers on board less than or equal to 19.

### BRIEF SUMMARY OF THE DRAWINGS

The invention will be better understood upon reading the following description, provided solely as a non-limiting example and done in reference to the drawings, in which:

FIG. 1 is a schematic top view of a detail of an aircraft according to a first embodiment of the invention;

FIG. 2 is a schematic front view of the entry area of the aircraft of FIG. 1 from the boarding door;

FIG. 3 is a schematic perspective view of the entry area of the aircraft of FIG. 1;

FIG. 4 is a schematic top view of a detail of an aircraft according to a second embodiment of the invention;

FIG. 5 is a schematic top view of a detail of an aircraft according to a third embodiment of the invention.

### DETAILED DESCRIPTION

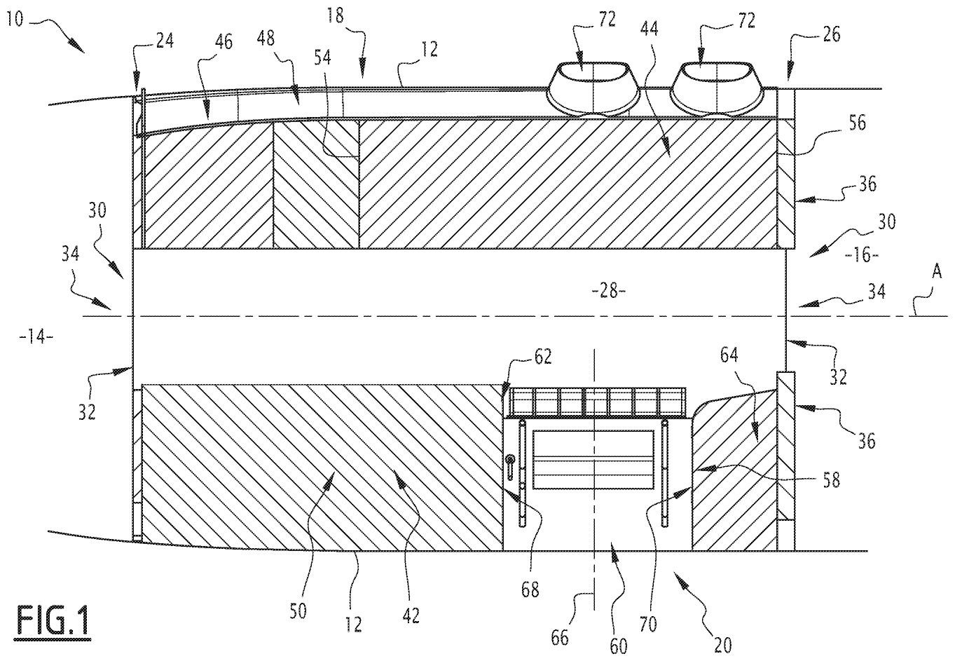

A detail of an aircraft 10 according to a first embodiment of the invention is illustrated in FIG. 1.

The aircraft 10 preferably has a maximum takeoff weight (MTOW) of less than 55,000 kg.

Additionally, the aircraft 10 is configured for a maximum permissible number of passengers on board (PAX) less than or equal to 19.

It is for example a business airplane.

The aircraft 10 comprises a fuselage 12 extending along a longitudinal axis A.

As illustrated in FIG. 1, the fuselage 12 delimits a cockpit 14, a passenger cabin 16, and a passenger entry area 18.

The fuselage 12 also delimits a side passenger boarding door 20.

In the embodiment of FIGS. 1 to 3, the fuselage 12 thus only delimits one side boarding door 20 in the entry area 18. In a variant, the fuselage 12 delimits another side boarding door in the entry area 18 arranged on the side of the fuselage 12 opposite that of said boarding door 20. The fuselage 12 thus at most delimits one side boarding door per lateral side of the fuselage 12 in the entry area 18.

The cockpit 14 designates the area reserved for crewmembers forming the technical navigating personnel, such as the pilot and the copilot.

The cockpit 14 is located at the front of the fuselage 12.

In a known manner, it includes the instrumentation intended for the piloting and management of the aircraft, and seats accommodating the pilot and the copilot.

The cabin 16 is intended to accommodate the passengers of the aircraft 10 during a flight phase of the aircraft 10.

It typically comprises seats for accommodating the passengers during flight.

The cabin 16 advantageously comprises other furniture elements, such as tables or trays.

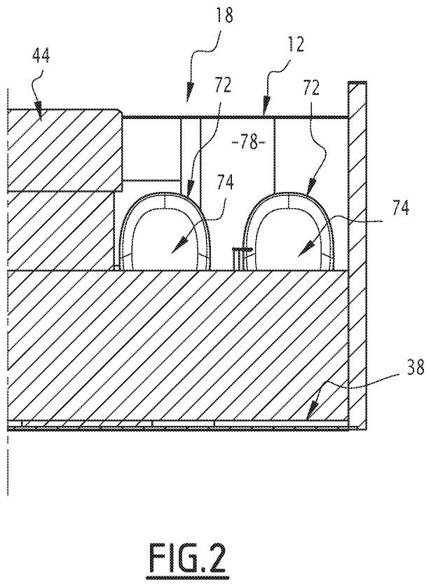

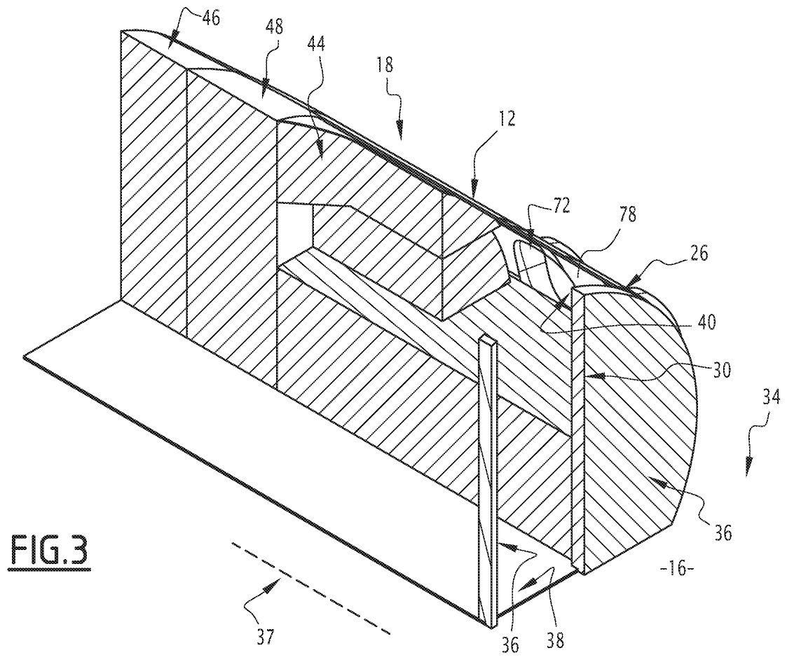

The entry area 18 is illustrated in more detail in FIGS. 2 and 3.

It is interposed longitudinally between the cockpit 14 and the cabin 16.

The entry area 18 and the cockpit 14 are delimited relative to one another by a front separating element 24. Additionally, the entry area 18 and the cabin 16 are delimited relative to one another by a rear separating element 26.

The entry area 18 comprises a central circulation passage 28 connecting the front separating element 24 to the rear separating element 26.

The front separating element 24 and the rear separating element 26 each comprise a frame 30 delimited by the fuselage 12 and a concealing element 32 received in the frame 30.

The frame 30 defines a passage section 34.

A user uses this passage section 34 to go from the entry area 18 to the cockpit 14 for the front separating element 24, or from the entry area 18 to the cabin 16 for the rear separating element 26.

Here and hereinafter, the terms “horizontal” and “vertical” are to be understood with respect to a position on the ground of the aircraft 10.

The central circulation passage 28 goes through said passage section 34 of each of the front and rear separating elements 24, 26.

The frame 30 extends over the entire height of the fuselage 12.

The frame 30 is stationary relative to the fuselage 12.

As illustrated in particular in FIG. 3, the frame 30 is for example laterally delimited by panels 36 secured to the fuselage 12. In this figure, for simplicity reasons, the concealing element has not been shown.

In this FIG. 3, a lower edge of the boarding door 20 has been illustrated and referenced by numerical reference 37.

The panels 36 thus extend from a floor 38 of the central circulation passage 28 to a ceiling 40 of the fuselage 12.

For clarity reasons, the concealing elements have not been shown in FIG. 2.

The concealing element 32 is for example a door or a curtain.

The concealing element 32 is able to obstruct the passage section 34 or to free access thereto.

As shown in FIG. 1, the entry area 18 is devoid of another separating element distinct from the front and rear separating elements 24, 26.

Advantageously, the front separating element 24 is the only transverse separating element moving from the side boarding door 20 toward the cockpit 14. The rear separating element 26 is the only transverse separating element moving from the side boarding door 20 toward the cabin 16.

In the example of FIG. 1, the entry area 18 comprises at least one crew rest area 42, at least one galley 44 intended for in-flight passenger services, and a toilet area 46.

The entry area 18 also comprises at least one closet 48.

The elements of the entry area 18 are illustrated schematically in the figures in the form of crosshatched blocks.

The crew rest area 42 and the galley 44 are arranged on either side of the central circulation passage 28.

The crew rest area 42 comprises a rest surface 50 on which a resting crewmember can sit and/or lie down, while another resting crewmember stays on duty.

The crew rest area 42 also for example comprises a closet, this closet then not being separated from the rest surface 50. In particular, no partition then separates this closet and the rest surface 50.

The crew rest area 42 is arranged on the same side of the fuselage 12 as the boarding door 20. It is also arranged longitudinally between the cockpit 14 and the boarding door 20.

The length of the crew rest area 42, considered along the longitudinal axis A of the aircraft, is advantageously greater than a regulatory minimum length. For example, this length is greater than 2 m.

The galley 44 is configured to be used by navigating personnel, such as flight attendants, to provide services, in particular catering, to the passengers during flight.

The galley 44 is arranged at least partially across from the passenger boarding door 20.

The galley 44 is wider than the boarding door 20 along the longitudinal axis A.

More specifically, the galley 44 extends longitudinally between a front end 54 and a rear end 56, the front end 54 of the galley 44 being arranged along the longitudinal axis A between the cockpit 14 and the boarding door 20, and the rear end 56 of the galley 44 being arranged along the longitudinal axis A between the boarding door 20 and the passenger cabin 16.

The galley 44 is in particular adjoined to the rear separating element 26.

Here and hereinafter, the expression “a first element is adjoined to a second element” means that the first element stops where the second element begins, or that the first and second elements are only separated by a partition. In particular, this expression means that the entry area 18 is devoid of empty space, in particular storage space between the first and second elements.

The entry area 18 is devoid of galley arranged on the same side of the fuselage 12 as the boarding door 20 relative to the central circulation passage 28.

As illustrated in FIG. 1, the toilet area 46 is arranged on the side of the fuselage 12 opposite that of the boarding door 20 relative to the central circulation passage 28.

The toilet area 46 is interposed longitudinally between the cockpit 14 and the galley 44. Here, it is adjoined to the front separating element 24.

The toilet area 46 is therefore not visible from the boarding door 20.

The toilet area 46 typically comprises a toilet and for example a sink.

Additionally, the closet 48 is interposed between the toilet location 46 and the galley 44.

The closet 48 is in particular adjoined to the toilet area 46 on the one hand and the galley 44 on the other hand.

The closet 48 is in particular respectively separated from the toilet area 46 and the galley 44 by a partition.

The closet 48 advantageously has a length, considered along the longitudinal axis A, sufficient to be able to store hanging clothing therein.

The boarding door 20 comprises a leaf 60 attached on a stationary part of the fuselage, movable relative to this stationary part between an access position to the entry area 18 of the aircraft 10, in which passengers can access the aircraft 10, and a closing position of said access, as illustrated in FIG. 1.

The a boarding door 20 opens in the central area 18, in particular on the central circulation passage 28.

Advantageously, in the example of FIG. 1, the boarding door 20 is adjoined to the rest area 42. Thus, the boarding door 20 and the rest area 42 are only separated by a partition 62.

Thus, the entry area 18 is in particular devoid of storage area between the rest area 42 and the boarding door 20.

In the first embodiment, the entry area 18 comprises a storage area 64 interposed between the boarding door 20 and the rear separating element 26, the boarding door 20 and the storage area 64 being separated by a partition 58. The passenger boarding door 20 is thus not adjoined to the rear separating element 26.

The storage area 64 is for example a closet.

The storage area 64 thus advantageously has a length, considered along the longitudinal axis A, sufficient to be able to store hanging clothing therein.

A transverse median plane 66 of the passenger boarding door 20 is placed at a distance from the front separating element 24, considered along the longitudinal axis A, greater than 39% of the length between the front separating element 24 and the rear separating element 26, considered along the longitudinal axis A.

“Length between the front separating element 24 and the rear separating element 26” refers to the length between their respective frames.

This median plane 66 is in particular transverse relative to the longitudinal axis A.

It is median between a first free lateral edge 68 and a second free lateral edge 70 of the door 20 in the closed position, as illustrated in FIG. 1.

The free lateral edges 68 and 70 laterally delimit an opening through which passengers enter the aircraft 10.

In the first embodiment, the median plane 66 is in particular placed at a distance from the front separating element 24, considered along the longitudinal axis A, greater than 70% of the length between the front separating element 24 and the rear separating element 26, considered along the longitudinal axis A.

Advantageously, the median plane 66 is placed at a distance from the front separating element 24, considered along the longitudinal axis A, substantially equal to 71% of the length between the front separating element 24 and the rear separating element 26, considered along the longitudinal axis A.

As illustrated in FIG. 2, at least one porthole 72 is arranged laterally in the fuselage 12 across from the passenger boarding door 20. In the illustrated example, two portholes 72 are arranged in this way.

Each porthole 72 comprises a glass 74 and a concealing device, not shown, movable between a position concealing the glass 74 and a position freeing the glass 74.

Each porthole 72 thus emerges in the entry area 18.

Each porthole 72 extends substantially in a vertical plane, perpendicular to the longitudinal axis A. “Substantially in a vertical plane” means that the porthole 72 can optionally have a curve associated with the curve of the fuselage 12.

The entry area 18 is arranged so that at least part of each porthole 72 is visible from the boarding door 20.

To that end, as illustrated in FIG. 2, the entry area 18 has a clear side area 78, comprising at least one part of each porthole 72, and which is not obstructed by the galley 44.

In particular, this clear area 78 is not obstructed when it is viewed from the boarding door 20.

The fuselage 12 is devoid of door placed longitudinally across from the boarding door 20.

Upon entering the aircraft, a passenger enters the aircraft without being placed directly across from the door to the toilet area, but rather in a partially clear area having a satisfactory esthetic appearance.

Additionally, the presence of portholes 72 improves the brightness in the entry area 18 and therefore the feeling of the passengers during their entry.

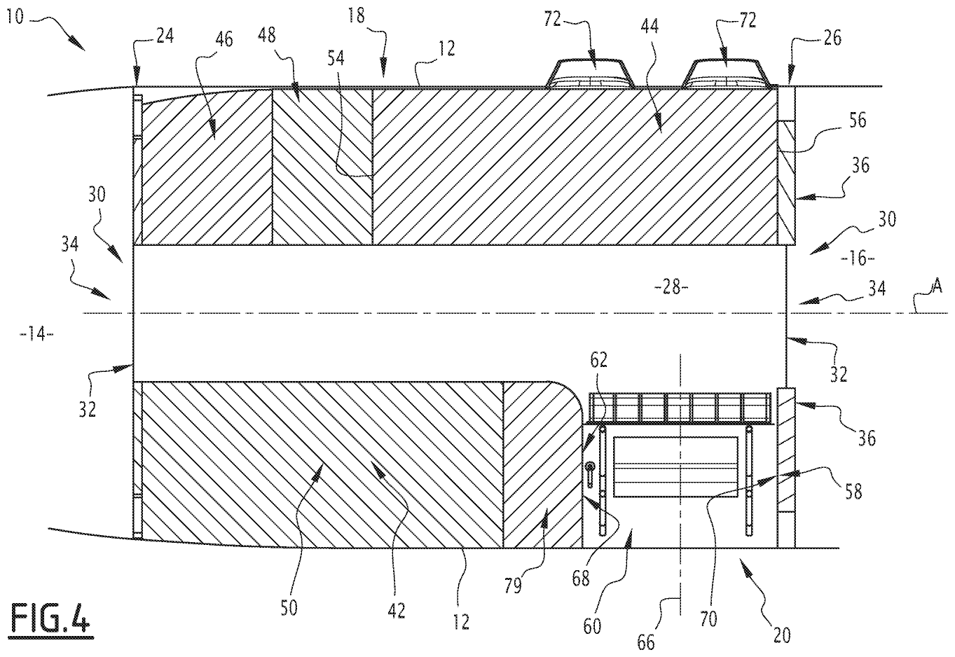

A second embodiment of the aircraft according to the invention will now be disclosed, in reference to FIG. 4.

This second embodiment differs from the first embodiment disclosed above in that the passenger boarding door 20 is adjoined to the rear separating element 26.

Thus, the boarding door 20 and the rear separating element 26 are only separated by a partition 58 separate from the panels 36 of the frame 30. In a variant, the partition 58 is combined with one of the panels 36 such that the second free side edge 70 is formed by one of the panels 36 of the frame 30.

In the second embodiment, the median plane 66 is in particular placed at a distance from the front separating element 24, considered along the longitudinal axis A, greater than 75% of the length between the front separating element 24 and the rear separating element 26, considered along the longitudinal axis A.

Advantageously, the median plane 66 is placed at a distance from the front separating element 24, considered along the longitudinal axis A, substantially equal to 78% of the length between the front separating element 24 and the rear separating element 26, considered along the longitudinal axis A.

Furthermore, the second embodiment differs from the first embodiment in that the entry area 18 comprises a storage area 79 interposed between the boarding door 20 and the rest area 42, the storage area 79 and the boarding door 20 being separated by a partition 62.

The passenger boarding door 20 is thus not adjoined to the rest area 42.

The storage area 79 is for example a closet.

The storage area 79 thus advantageously has a length, considered along the longitudinal axis A, sufficient to be able to store hanging clothing therein.

The storage area 79 is also separated from the rest area 42 by a partition.

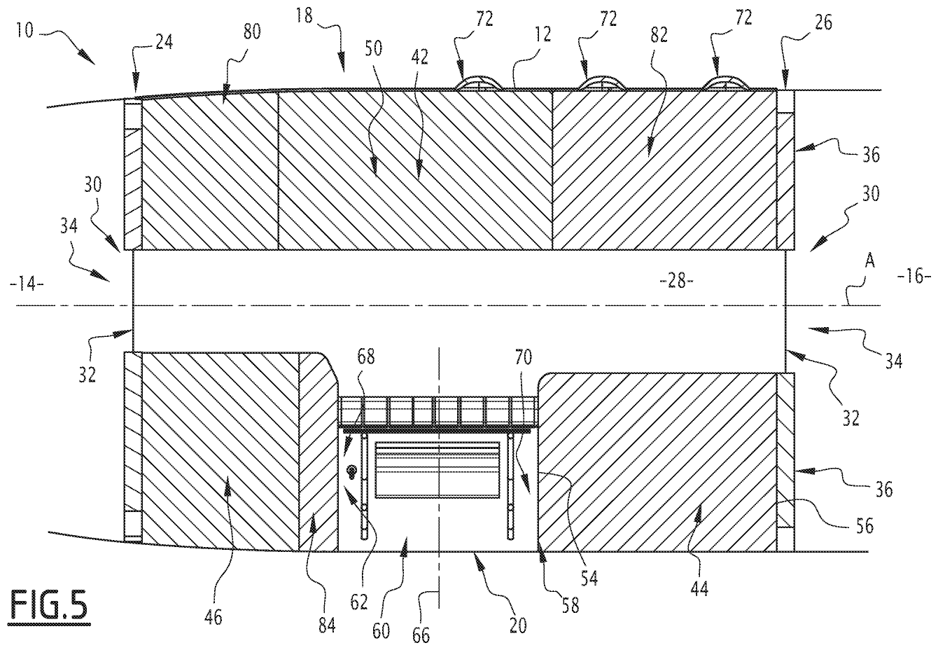

A third embodiment of the aircraft according to the invention will now be disclosed, in reference to FIG. 5.

This third embodiment differs from the first embodiment disclosed above in that the median plane 66 is placed at a distance from the front separating element 24, considered along the longitudinal axis A, between 39% and 50% of the length between the front separating element 24 and the rear separating element 26, considered along the longitudinal axis A.

Advantageously, the median plane 66 is placed at a distance from the front separating element 24, considered along the longitudinal axis A, equal to 45% of the length between the front separating element 24 and the rear separating element 26, considered along the longitudinal axis A.

Preferably, the minimum distance, considered along the longitudinal axis A, separating the front separating element 24 and a first free side edge 68 of the boarding door 20 is greater than 0.9 m.

Additionally, this third embodiment differs from the first embodiment in that the crew rest area 42 is arranged on the side of the fuselage 12 opposite the boarding door and facing the boarding door 20.

The crew rest area 42 is wider than the boarding door 20.

The crew rest area 42 for example stops longitudinally at the same level as the second free side edge 70 of the boarding door 20.

Furthermore, a closet 80 is interposed between the rest area 42 and the cockpit 14.

The rest area 42 is adjoined to the closet 80.

The closet 80 is in particular separated from the rest area 42 by a partition.

Additionally, the closet 80 is adjoined to the front separating element 24.

The closet 80 advantageously has a length, considered along the longitudinal axis A, sufficient to be able to store hanging clothing therein.

The third embodiment also differs from the first embodiment in that the galley 44 is arranged on the same side of the fuselage 12 as the boarding door 20. The galley 44 is also arranged longitudinally between the boarding door 20 and the cabin 16.

The galley 44 is advantageously adjoined to the boarding door 20 and the rear separating element 26. Thus, the entry area 18 is in particular devoid of storage area between the galley 44 and the boarding door 20.

The third embodiment also differs from the first embodiment in that the entry area 18 also comprises an annex 82 to the galley 44, the annex 82 being intended for in-flight passenger services.

The annex 82 is also configured to be used by the navigating personnel to provide services, in particular catering, to the passengers during flight.

The annex 82 forms a piece of furniture, and its storage areas are preferably able to be opened and closed.

The annex 82 is arranged at least partially across from the galley 44.

The annex 82 and the galley 44 in this example have substantially the same length, considered along the longitudinal axis A of the aircraft.

The annex 82 is adjoined to the crew rest area 42.

Additionally, the annex 80 is adjoined to the rear separating area 26.

Furthermore, the third embodiment differs from the first embodiment in that the toilet area 46 is arranged on the same side of the fuselage 12 as the boarding door 20.

The toilet area 46 and the crew rest area 42 are arranged on either side of the central circulation passage 28.

The toilet area 46 is arranged on the same side of the fuselage 12 as the boarding door 20.

The toilet area 46 is also arranged longitudinally between the cockpit 14 and the boarding door 20.

The toilet area 46 is adjoined to the front separating element 24.

The entry area 18 comprises a storage area 84 interposed between the boarding door 20 and the toilet area 46. The passenger boarding door 20 is thus not adjoined to the toilet area 46.

The transverse partition 62 longitudinally separates the storage area 84 from the boarding door 20.

Owing to the features previously disclosed, the passengers no longer have to cross an aisle to access the cabin 16. The passengers' comfort upon entering the aircraft 10 is therefore improved.

Furthermore, the specific arrangement of the entry area 18 reduces circulation conflicts between the navigating personnel and the passengers, when passengers board the aircraft 10. Indeed, the navigating personnel can stand back toward the cockpit 14 and not in the path of passengers moving toward the cabin 16.

The specific arrangement of the entry area 18 also makes it possible to reduce circulation conflicts between resting crewmembers taking advantage of the rest area 42 and the rest of the navigating personnel of the aircraft 10. Indeed, the rest area 42 is offset relative to the galley 44, which avoids traffic crossings.

What is claimed is:

1. An aircraft comprising:
a fuselage, the fuselage extending along a longitudinal axis and delimiting a cockpit, a passenger entry area, and a passenger cabin, the cabin being configured to accommodate passengers of the aircraft during a flight phase of the aircraft, the entry area being interposed longitudinally between the cockpit and the cabin;
the fuselage including a front separating element delimiting the cockpit and the entry area;
the fuselage including a rear separating element delimiting the entry area and the cabin;
the fuselage delimiting a side passenger boarding door opening in the entry area;
a transverse median plane of the side passenger boarding door being placed at a distance from the front separating element, considered along the longitudinal axis, greater than 39% of the length between the front separating element and the rear separating element, considered along the longitudinal axis.

2. The aircraft according to claim 1, wherein the entry area comprises at least one crew rest area, the crew rest area comprising a rest surface configured for a resting crew member to sit and/or lie down on, the crew rest area being arranged on a side of the fuselage opposite the side passenger boarding door and facing the side passenger boarding door.

3. The aircraft according to claim 1, wherein the entry area comprises at least one crew rest area, the crew rest area comprising a rest surface configured for a resting crew member to sit and/or lie down on, the crew rest area being arranged on a same side of the fuselage as the side passenger boarding door and being arranged longitudinally between the cockpit and the side passenger boarding door.

4. The aircraft according to claim 1, wherein the distance of the transverse median plane from the front separating element, considered along the longitudinal axis, is greater than 70% of the length between the front separating element and the rear separating element, considered along the longitudinal axis.

5. The aircraft according to claim 1, wherein the distance of the transverse median plane from the front separating element, considered along the longitudinal axis, is less than 50% of the length between the front separating element and the rear separating element, considered along the longitudinal axis.

6. The aircraft according to claim 1, wherein a minimum distance, considered along the longitudinal axis, separating the front separating element and a first free side edge of the side passenger boarding door is greater than 0.9 m.

7. The aircraft according to claim 1, wherein the front separating element and the rear separating element each comprise a frame delimited by the fuselage and a concealing element received in the frame.

8. The aircraft according to claim 7, wherein the concealing element is a door or a curtain.

9. The aircraft according to claim 1, wherein the side passenger boarding door is adjoined to the rear separating element.

10. The aircraft according to claim 1, wherein the entry area comprises a storage space between the side passenger boarding door and the rear separating element.

11. The aircraft according to claim 1, wherein at least one porthole is arranged laterally in the fuselage across from the side passenger boarding door.

12. The aircraft according to claim 1, wherein the entry area comprises at least one galley configured for in-flight passenger services, the galley being arranged at least partially across from the side passenger boarding door.

13. The aircraft according to claim 12, wherein the entry area comprises at least one crew rest area, the crew rest area comprising a rest surface configured for a resting crew member to sit and/or lie down on, the crew rest area being arranged on a same side of the fuselage as the side passenger boarding door and being arranged longitudinally between the cockpit and the side passenger boarding door, and wherein the entry area comprises a central circulation passage connecting the front separating element to the rear separating element, the crew rest area and the galley being arranged on either side of the central circulation passage.

14. The aircraft according to claim 1, wherein the entry area is devoid of any other separating element, comprising a frame delimited by the fuselage and a concealing element received in the frame, distinct from the front and rear separating elements.

15. The aircraft according to claim 1, wherein the fuselage is devoid of a door placed longitudinally across from the side passenger boarding door.

16. The aircraft according to claim 1, having a maximum takeoff weight of less than 55,000 kg and/or is configured for a maximum permissible number of passengers on board less than or equal to 19.
